(19) United States
(12) Patent Application Publication
(10) Pub. No.: US 2018/0103153 A1
(43) Pub. Date: Apr. 12, 2018

(54) Inmate-Related Communications Opt-In Protocols

(71) Applicant: Intelmate LLC, San Francisco, CA (US)

(72) Inventors: Richard Torgersrud, San Francisco, CA (US); Christopher Ditto, San Jose, CA (US); Nick Garcia, Oakland, CA (US); Grant Gongaware, Alameda, CA (US)

(73) Assignee: Intelmate LLC, San Francisco, CA (US)

(21) Appl. No.: 15/599,462

(22) Filed: May 18, 2017

Related U.S. Application Data
(60) Provisional application No. 62/338,471, filed on May 18, 2016.

(51) Int. Cl. H04M 15/08; H04M 15/00; H04M 3/42; H04M 3/533

(52) U.S. Cl. CPC H04M 15/08; H04M 15/72; H04M 2215/7036; H04M 3/533; H04M 2215/62; H04M 3/4211

(57) ABSTRACT

An exemplary embodiment provides for a computer-implemented method for prior opted-in call acceptance-assisted message delivery. The method includes receiving a destination number, of a called party, for a telephone call from an inmate in a secure facility, determining, based on the destination number, if the called party had opted-in to automatically be connected to telephone calls from the secure facility and connecting the telephone call to the called party, if opted-in. Also, if the called party is not available to receive the call, receiving a message for the called party from the inmate.

### CROSS-REFERENCE TO RELATED APPLICATIONS

This application hereby claims the benefit of priority of U.S. Provisional Patent Application Ser. No. 62/338,471, filed on May 18, 2016, entitled “INMATE-RELATED COMMUNICATIONS OPT-IN PROTOCOLS,” and is herein incorporated by reference.

### BACKGROUND

Traditionally, telephonic communications from an incarcerated individual, to their friends and family, is prefaced with a warning message to the friend or family member that they are about to receive a phone call from the incarcerated individual and are further instructed to actively press a button or verbally agree to accept the call before being connected to the incarcerated individual. Even on subsequent calls, the called party is typically still required to press a button or verbally agree to accept the call or similar before an actual voice connection is established.

This practice may unintentionally limit communications, though. For example, if the called party misses a call due to various reasons which may include: not being at their phone or being in situations where they cannot (while on the job, for example) or perhaps intentionally choose to not accept phone calls (exercising or perhaps while in church or other similar situations). In any of these aforementioned situations, and perhaps others too, fewer calls will be completed.

While there are legitimate concerns regarding telephone calls from incarcerated individuals, there is also a need to help incarcerated individuals maintain ties with the outside world as such ties tend to reduce recidivism. Therefore, there is a need to optimally balance these two incongruent goals.

The foregoing examples of the related art and limitations related therewith are intended to be illustrative and not exclusive. Other limitations of the related art will become apparent to those of skill in the art upon a reading of the specification and a study of the drawings.

### SUMMARY

An exemplary embodiment provides for a computer-implemented method for prior opted-in call acceptance-assisted message delivery. The method includes receiving a destination number, of a called party, for a telephone call from an inmate in a secure facility, determining, based on the destination number, if the called party had opted-in to automatically be connected to telephone calls from the secure facility and connecting the telephone call to the called party, if opted-in. Also, if the called party is not available to receive the call, receiving a message for the called party from the inmate.

As will be seen upon study and review of the enclosed description and related figures, diagrams and charts, the claimed embodiments solves various deficiencies of prior art systems. One example, of many, is that the claimed embodiments allow for incarcerated individuals to leave a message even if the called party cannot answer a call. For example, application of the claimed embodiments will typically result in increased communications and lower inmate population levels.

### BRIEF DESCRIPTION OF THE DRAWINGS

Exemplary embodiments are illustrated in referenced figures of the drawings. It is intended that the embodiments and figures disclosed herein are to be considered illustrative rather than limiting.

FIGS. 1, 2, 3, 4, 5A, 5B and 6 are schematic diagrams of an example secure facility call management system that may be used in conjunction with the claimed embodiments;

FIGS. 7, 8, 9 and 10 are schematic diagrams that illustrate methods and system for identity verification in a detention environment;

FIG. 11 is a flowchart diagram illustrating how an inmate call is handled based on the payment type of the call and further in relation to a called party's opt-in status;

FIG. 12 is a chart diagram illustrating construction of applicable greetings played to a called party dependent on call type and opt-in/opt-out status;

FIG. 13 is a flowchart diagram illustrating an example interactive voice response system which provides, for a friend/family member, self-service options to update/modify opt-in-related parameters; and

FIG. 14 is a flow chart diagram illustrating a computer-implemented method for prior opted-in call acceptance-assisted message delivery.

### DETAILED DESCRIPTION

Specific descriptions of inmate-related communication opt-in protocols is presented in later sections of the detailed description as various related methods and systems will firstly be presented. These related method and systems are example implementations upon which the claimed embodiments may be practiced and used in conjunction. As they are examples, it will therefore be appreciated that other methods and systems could also be utilized in harmony with various implementations of the claimed embodiments.

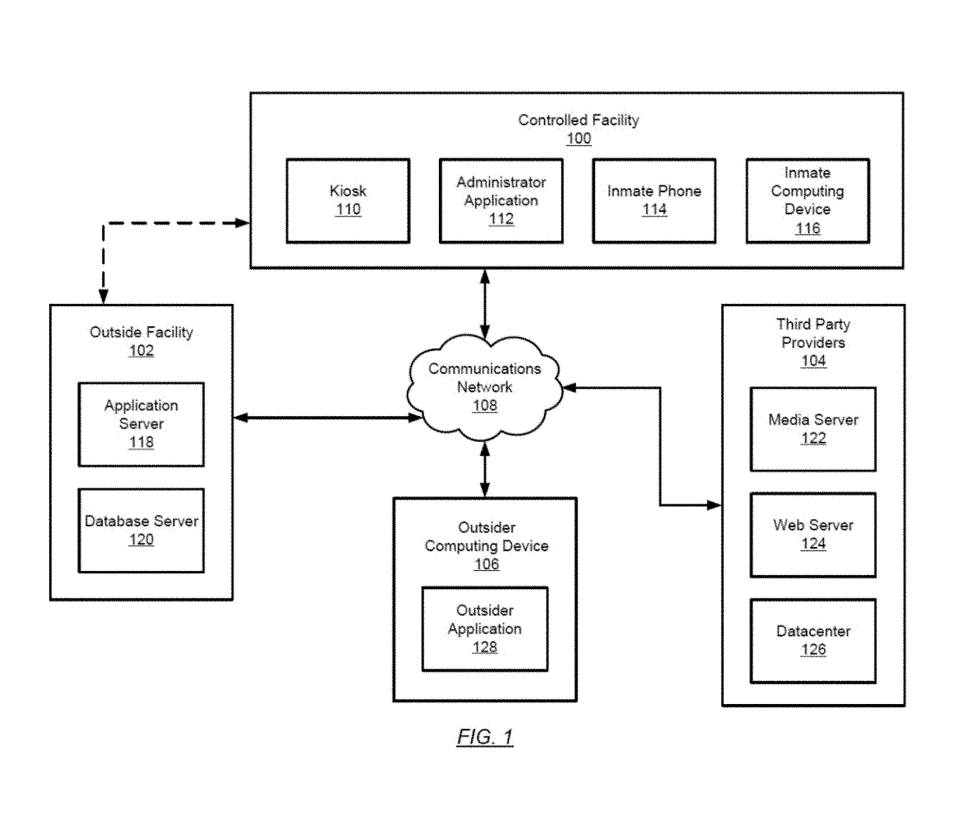

Starting with FIG. 1, FIG. 1 shows a diagram of a system in accordance with at least one implementation of the claimed embodiments. As shown in FIG. 1, the system includes a controlled facility (100), an outside facility (102), third-party providers (104), and an outsider computing device (106) each communicatively coupled to a communications network (108). The controlled facility (100) may include, but is not limited to, a kiosk (110), an administrator application (112), an inmate phone (114), and an inmate computing device (116). The outside facility (102) may include an application server (118) and a database server (120). The third-party providers (104) may include a media server (122), a web server (124), and a datacenter (126). The outsider computing device (106) may include an outsider application (128).

In at least one implementation of the claimed embodiments, a controlled facility (100) is an access-restricted location. Examples of controlled facilities (e.g., controlled facility (100)) include, but are not limited to, detention environments (e.g., jails, prisons, etc.), immigration detention centers, military centers, government secure sites, law enforcement holding structures, secure business complexes, and psychiatric hospitals.

In at least one implementation of the claimed embodiments, an inmate is a person within a controlled facility (100) who is subject to one or more restrictions, primarily to his or her freedom or rights. Examples of inmates include, but are not limited to, prisoners, wards of the state, parolees, employees working in a secure business complex, temporary or long-term internees, patients, military personnel, uncharged suspects, and refugees. Inmate restrictions may be part of a court-imposed sentence on an inmate, while others may be specific to the controlled facility (100) in which the inmate resides. Restrictions may include limitations on an inmate's physical movement (i.e., physical restrictions) and limitations on the inmate's ability to communicate (i.e., communication restrictions). Communication restrictions include inmate use restrictions, inmate target restrictions, and device use restrictions.

In at least one implementation of the claimed embodiments, inmate use restrictions are limitations on an inmate's general ability to communicate with visitors and/or outsiders. Inmate use restrictions may include, for example, periods of time in which an inmate is not allowed to communicate with outsiders or visitors (e.g., between 10 PM and 8 AM, during an imposed one-week punitive period, etc.) and limitations based on lack of funds (e.g., insufficient commissary account balance to initiate a communication).

In at least one implementation of the claimed embodiments, inmate target restrictions are limitations on the target or source of a communication with the inmate. Inmate target restrictions may be specific outsiders or visitors with whom the inmate is not allowed to communicate (e.g., the victim of a crime perpetrated by the inmate, etc.). Inmate target restrictions may also include types of people with whom the inmate is not allowed contact (e.g., outsiders who are ex-cons, minors under the age of 18, etc.).

In at least one implementation of the claimed embodiments, device use restrictions are restrictions based on the condition or state of the communication device used by the inmate. Device use restrictions include, for example, limitations based on the location of the inmate's mobile device, limitations imposed based on a determination that the device has been tampered with, etc.

In at least one implementation of the claimed embodiments, an outsider is a person outside the controlled facility (100) who may be the source or target of a communication with an inmate. An outsider who enters the controlled facility (100) for the purpose of communicating with an inmate is referred to as a visitor.

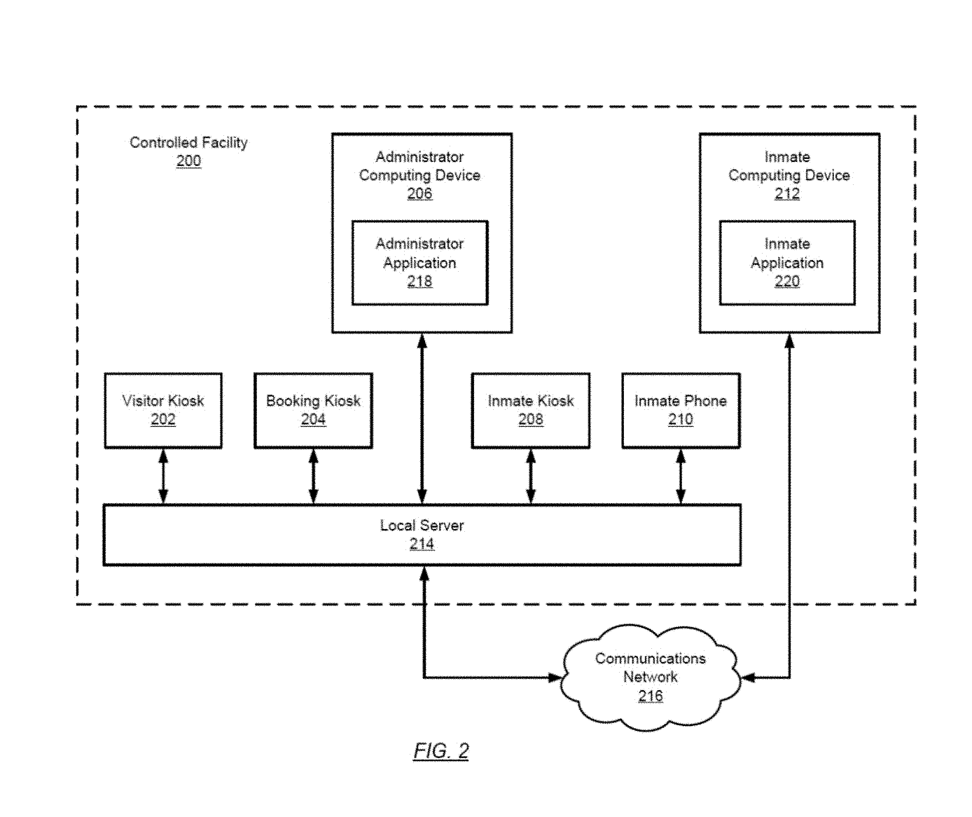

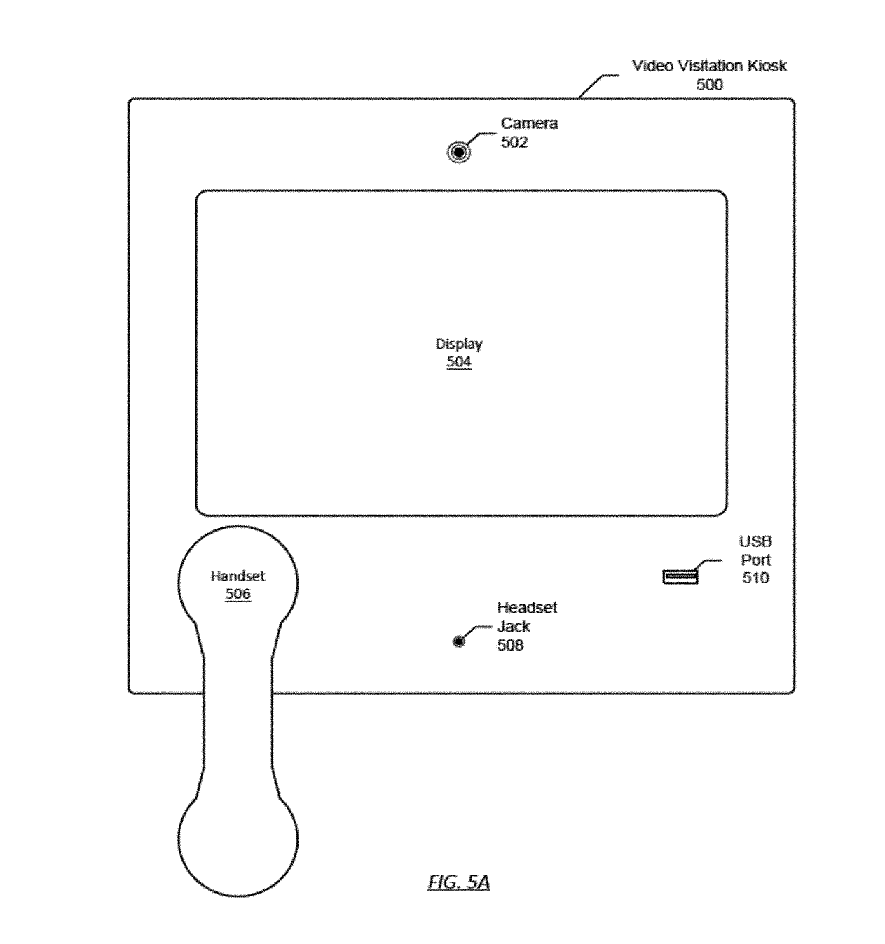

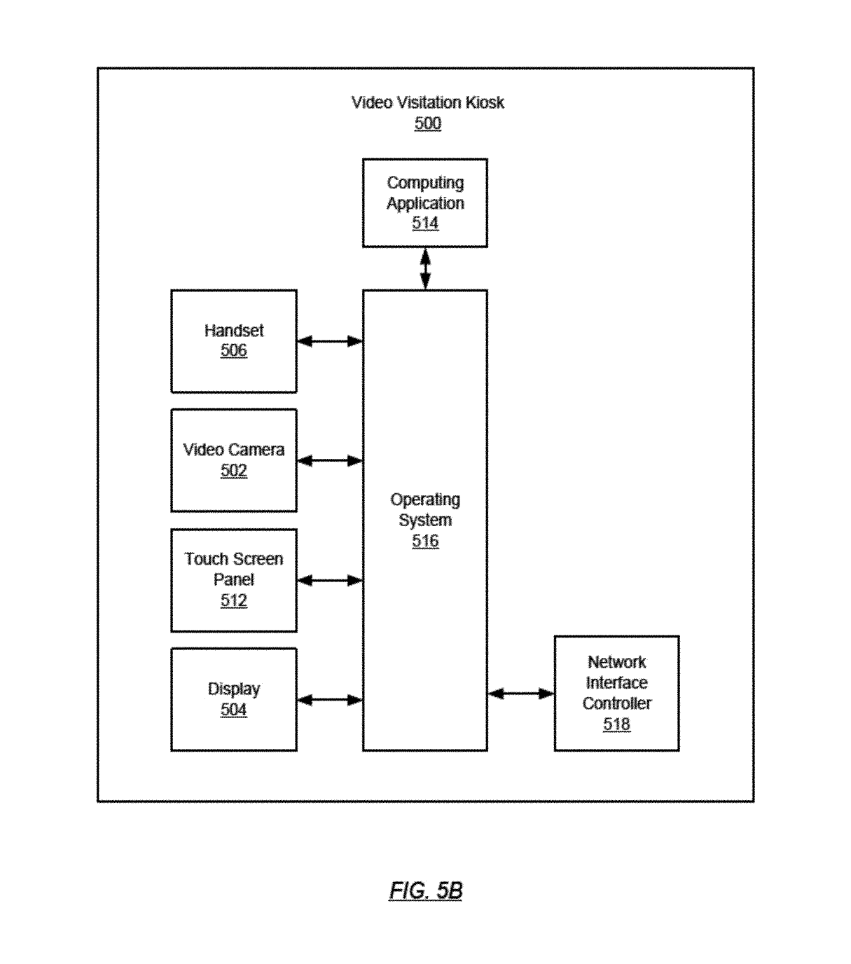

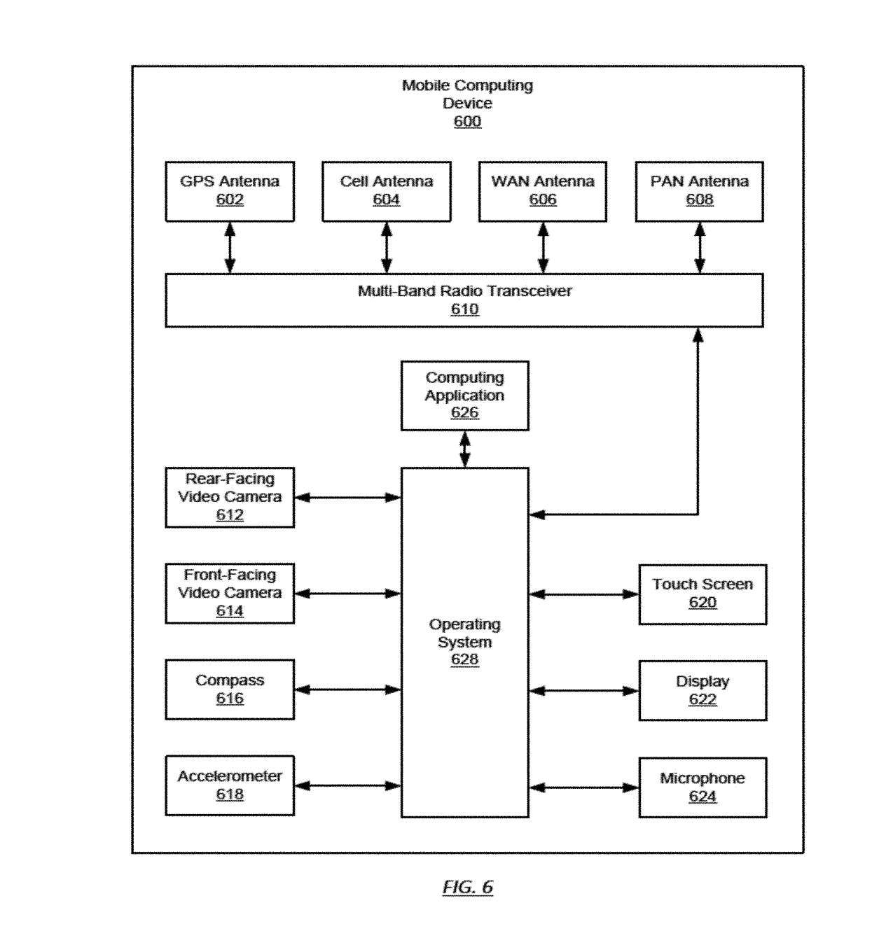

In at least one implementation of the claimed embodiments, the kiosk (110) is a computing system with functionality to facilitate communication between an inmate and a visitor or outsider. Such communication facilitation may include creating a system identity data item or secure social networking account, adding or importing contact information for outsiders with whom the inmate wishes to communicate, uploading media (e.g., photos, videos, audio, and text) to, or viewing media from, a secure social network, sending or receiving messages or other media, acting as an endpoint for voice and video communication between an inmate and a visitor or outsider, scheduling a communication, and managing a commissary or communications account. Further detail about kiosks (e.g., kiosk (110)) is provided in FIG. 2, FIG. 5A, FIG. 5B, and FIG. 6. Kiosks may also, in some implementations, be deployed outside of controlled facility 100.

In at least one implementation of the claimed embodiments, the administrator application (112) is a process or group of processes executing on a computing system with functionality to enable an administrator to create, remove, and/or enforce one or more restrictions on an inmate. In at least one implementation of the claimed embodiments, an administrator is a person associated with the controlled facility charged with enforcing one or more restrictions. Examples of administrators include, but are not limited to, prison guards, orderlies, wardens, prison staff, jailers, information technology technicians, system administrators, and law enforcement agents. Using the administrator application, an administrator may retrieve or alter the identity data item and/or secure social network account of an inmate, visitor, or outsider. Further detail about the administrator application (112) is provided in FIG. 2.

In at least one implementation of the claimed embodiments, the inmate phone (114) is a device with functionality to send and receive audio communications between an inmate and an outsider or visitor. In at least one implementation of the claimed embodiments, the inmate phone (114) is a stationary (i.e., non-mobile) device. Further, a single inmate phone (114) may be used by more than one inmate. Further detail about the inmate phone (114) is provided in FIG. 2.

In at least one implementation of the claimed embodiments, the inmate computing device (116) is a computing device with functionality to enable an inmate to communicate with a visitor or outsider. Specifically, the inmate computing device (116) may be used to send or receive text messages and/or initiate or receive voice or video calls. In at least one implementation of the claimed embodiments, the inmate computing device (116) also enables an inmate to access a secure social network. Specifically, the inmate computing device (116) may be used to upload media to, or view media from, a secure social network account of the inmate or another secure social network member. In at least one implementation of the claimed embodiments, the inmate computing device (116) is a mobile computing device (e.g., a smartphone, a laptop, a tablet, etc.). Further detail about the inmate computing device (116) is provided in FIG. 2 and FIG. 6.

In at least one implementation of the claimed embodiments, the elements within the controlled facility (100) are communicatively coupled to the communications network (108). In at least one implementation of the claimed embodiments, the communications network (108) is a collection of computing systems and other hardware interconnected by communication channels. The communications network (108) may include networks that are exclusively or primarily used for a single type of communication, such as a telephone network (e.g., Plain Old Telephone System (POTS)), and/or networks used for a wide array of communication types, such as the Internet through Voice over IP (VOIP). Communication channels used by the communications network (108) may include, for example, telephone lines, networking cables, wireless signals, radio waves, etc. Fees charged and payments received by the provider(s) of the communications network (108) may involve multiple parties, including a service provider of the outside facility (102), the management of the controlled facility (100), and provider(s) of the communications network (108). In at least one implementation of the claimed embodiments, fees may be split between multiple parties based on the terms of underlying agreements or contracts between the parties. Further, rebates, reimbursements, and/or refunds may be afforded to and paid to the management of the controlled facility (100) based on the terms of underlying agreements or contracts between the parties. For example, the management of the controlled facility (100) may receive a rebate from the service provider of the services provided to inmates based on such factors as the volume of use, the dollar amount, and/or the frequency of use.

In at least one implementation of the claimed embodiments, the outside facility (102) is a group of computing systems located outside of the controlled facility (100). Specifically, the outside facility (102) may house system elements with functionality to facilitate communication between inmates and outsiders, access communication data between inmates and outsiders, and enforce one or more restrictions imposed on inmates and inmate communications. In at least one implementation of the claimed embodiments, the outside facility (102) is connected directly to the controlled facility (100) bypassing a generally accessible communications network (communications network (108)). One or more of the components within the outside facility (102) may alternatively be located within the controlled facility (100) or within the third-party providers (104).

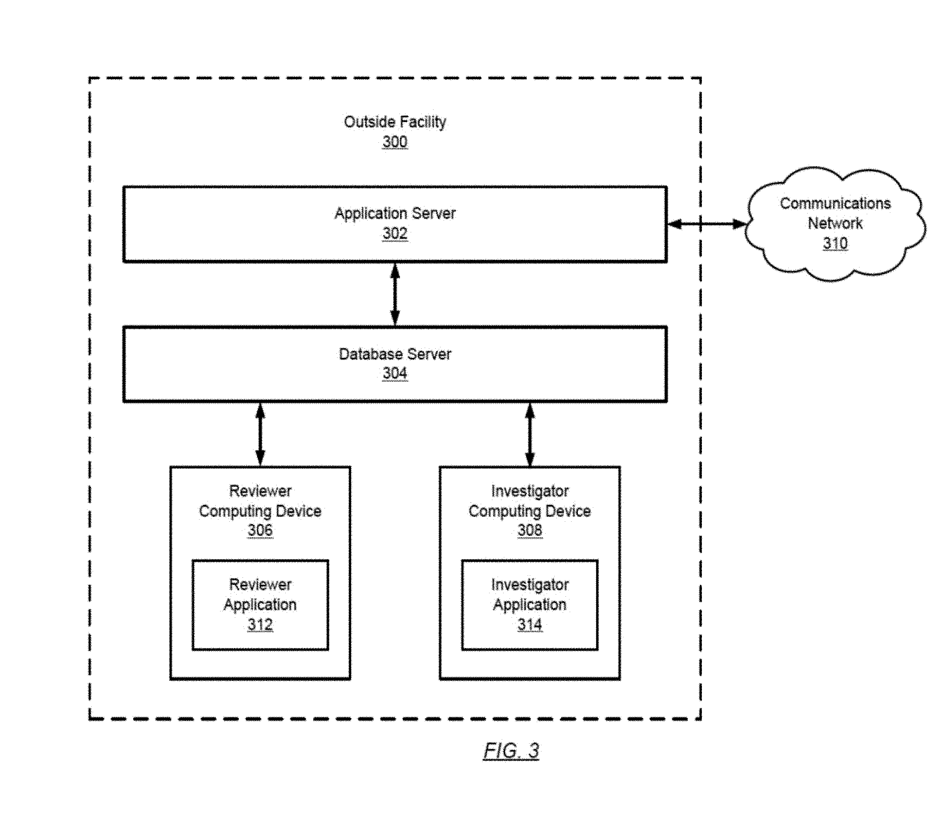

In at least one implementation of the claimed embodiments, the application server (118) is a computing system with functionality to authenticate an inmate, outsider, administrator, reviewer, or investigator for access to system functionality (e.g., initiating voice or video calls, sending text messages, etc.) or data stored on the database server (120) (e.g., inmate identities, communications between inmates and outsiders, etc.). The application server may authenticate inmates, outsiders, administrators, reviewers, and/or investigators using passwords, biometric data, digital access codes, and/or physical access devices. Further detail about the application server (118) is provided in FIG. 3.

In at least one implementation of the claimed embodiments, the database server (120) is a computing system with functionality to store identities used to authenticate inmates, outsiders, administrators, reviewers, and/or investigators. Such identities may include verified data used to compare to verification data provided by the inmate, outsider, administrator, reviewer, or investigator to authenticate the inmate, outsider, administrator, reviewer, or investigator.

In at least one implementation of the claimed embodiments, the database server (120) also stores communication data about communications between an inmate and an outsider or visitor. Such communication data may include, for example, a recording of a video call, the length of a voice call, the frequency of video calls, sent and received text messages, etc. The database server (120) may also store media submitted to a secure social network before, during, and/or after the media has been reviewed. Further detail about the database server (120) is provided in FIG. 3.

In at least one implementation of the claimed embodiments, the third-party providers (104) are computing systems that provide network application and data storage services (i.e., cloud computing services). Third-party providers (104) may include service providers used directly by inmates and outsiders, such as photo sharing services, general social networking sites, and digital music retailers. Third-party providers (104) may include service providers employed by administrators and for use by inmates and outsiders, such as audio and video streaming applications, conferencing applications, and secure social network media storage. One or more of the components within the third-party providers (104) may alternatively be located within the controlled facility (100) or the outside facility (102).

In at least one implementation of the claimed embodiments, the media server (122) is a computing system or group of computing system with functionality to provide network application services to facilitate communication between an inmate and an outsider, and to facilitate access to a secure social network. Such services include, but are not limited to, VoIP services, video conferencing services, and media streaming services.

In at least one implementation of the claimed embodiments, the web server (124) is a computing system or group of computing system with functionality to provide an interface to access and interact with webpages and other network application services. In at least one implementation of the claimed embodiments, the web server (124) is a type of media server (122).

In at least one implementation of the claimed embodiments, the datacenter (126) is a computing system or group of computing system with functionality to provide an interface to access and interact with data stored on one or more data servers (not shown). In at least one implementation of the claimed embodiments, the datacenter (126) is a type of media server (122).

In at least one implementation of the claimed embodiments, the outsider computing device (106) is a computing device with functionality to execute the outsider application (128). In at least one implementation of the claimed embodiments, the outsider computing device (106) is a mobile computing device (e.g., a smartphone, a laptop, a tablet, etc.). Further detail about the outsider computing device (106) is provided in FIG. 6.

In at least one implementation of the claimed embodiments, the outsider application (128) is a process or group of processes (in software, firmware, hardware, or combination thereof) with functionality to enable communication between an outsider and an inmate. Specifically, the outsider application (128) may be used to send or receive text messages and/or initiate or receive voice or video calls. In at least one implementation of the claimed embodiments, the outsider application (128) also enables an outsider to access a secure social network. Specifically, the outsider application (128) may be used to upload media to, or view media from, a secure social network account of the outsider, an inmate, and other secure social network member.

FIG. 2 shows a controlled facility in accordance with at least one implementation of the claimed embodiments. As shown in FIG. 2, the controlled facility (200) may include a visitor kiosk (202), a booking kiosk (204), an administrator computing device (206), an inmate kiosk (208), an inmate phone (210), an inmate computing device (212), and a local server (214). The inmate computing device (212) and the local server (214) are communicatively coupled to the communications network (216). The administrator computing device (206) includes an administrator application (218). The inmate computing device (212) includes an inmate application (220).

In at least one implementation of the claimed embodiments, the visitor kiosk (202) is a computing system with functionality to facilitate communication between an inmate and a visitor. Specifically, the visitor kiosk (202) may be a combination of computing hardware and software used by a visitor to make and receive voice and video calls to/from an inmate residing in the same controlled facility (200) or another controlled facility (not shown). The visitor kiosk (202) may also be used to schedule a voice or video call with an inmate for a future date. Further, the visitor kiosk (202) may also include the functionality to exchange media (e.g., photos, videos, and audio) with an inmate residing in the controlled facility (200). The visitor kiosk (202) may include functionality to generate such media, such as a camera, microphone, keyboard, and software to record or otherwise create media to send to an inmate. Such media may be subject to review before being delivered.

In at least one implementation of the claimed embodiments, a visitor wanting to use a visitor kiosk (202) may be required to participate in an authentication process to verify the identity of the visitor. The authentication process may include creating an identity data item and verified data for storage and later comparison. The verified data used for authentication may be a username and password combination and/or biometric information about the visitor.

In at least one implementation of the claimed embodiments, the visitor kiosk (202) includes functionality to access a secure social network. Specifically, the visitor kiosk (202) may be used by a visitor to create and manage a secure social network account. The visitor kiosk (202) may also be used by a visitor to upload digital media to the visitor's secure social network account or the account of another secure social network member. The visitor kiosk (202) may further be used to view digital media uploaded to the visitor's social network account or the account of another secure social network member.

In at least one implementation of the claimed embodiments, the visitor kiosk (202) includes functionality to manage a commissary account for one or more inmates. Specifically, a visitor may use a visitor kiosk (202) to add money to the commissary account of an inmate in the controlled facility (200), view a transaction history of the commissary account, transfer funds between commissary accounts, and/or remove funds from a commissary account. Further detail about the visitor kiosk (202) is provided in FIG. 5A and FIG. 5B.

In at least one implementation of the claimed embodiments, the booking kiosk (204) is a computing system with functionality to aid administrators in admitting an inmate into a controlled facility (e.g., controlled facility (200)). Specifically, the booking kiosk (204) may include functionality to create or update an inmate identity data item. Specifically, the booking kiosk (204) may be used to obtain verified data (e.g., passwords, biometric data, etc.) and save the verification data in one or more identity data items for the inmate. The verified data may then be used to authenticate the inmate (e.g., to access the communications network (216), etc.). In at least one implementation of the claimed embodiments, the booking kiosk may also be used to associate one or more restrictions with the inmate via the inmate's identity data item.

In at least one implementation of the claimed embodiments, the booking kiosk (204) includes functionality to input contact information for visitors, outsiders, administrators, or other inmates with whom the inmate wants to communicate. Such contact information may then be associated with the inmate's identity data item, and may be used to initiate a voice or video call, or otherwise transmit media to visitors, outsiders, or other inmates. Further, in at least one implementation of the claimed embodiments, the contact information may be retrieved from an inmate's mobile computing device (e.g., cell phone, smart phone, etc.) or a local or remote data storage device (e.g., a flash drive, a webmail account, etc.). The contact information may be retrieved using a wired or wireless connection between the booking kiosk and the inmate's mobile computing device and/or the data storage device. The contact information may be subject to review before the inmate is permitted to contact the visitor, outsider, administrator, or other inmate.

In at least one implementation of the claimed embodiments, the booking kiosk (204) includes functionality to prepare a mobile computing device for use by the inmate within the controlled facility (200). Specifically, a controlled facility (200) may allow inmates the use of computing devices while in or subject to the controlled facility (200). However, use of such inmate computing devices may require that the computing device is provisioned with software restricting the use of the inmate computing device. The booking kiosk (204) may be used to provision the inmate computing device as required. Further detail about the booking kiosk (204) is provided in FIG. 5A and FIG. 5B.

In at least one implementation of the claimed embodiments, the administrator computing device (206) is a computing system or group of computing systems with functionality to execute the administrator application (218). In at least one implementation of the claimed embodiments, the administrator application (218) is a process or group of process with functionality to provide access to communications between inmates at the controlled facility (200) and visitors, outsiders, administrator, and other inmates. The administrator application (218) may also be used to monitor current voice or video calls between an inmate and a visitor, outsider, administrator, or other inmate.

In at least one implementation of the claimed embodiments, the administrator application (218) is used to manage an identity data item associated with an inmate. Such management may include altering the restrictions (device use restrictions, inmate use restrictions, and inmate target restrictions) applicable to the inmate. In at least one implementation of the claimed embodiments, the administrator application (218) is used to access the secure social network account of an inmate, visitor, or outsider. In at least one implementation of the claimed embodiments, the administrator application (218) may provide heightened access (i.e., a level of access greater than that of the inmate, visitor, or outsider) to data stored in the secure social networking account.

In at least one implementation of the claimed embodiments, the inmate kiosk (208) is a computing system with functionality to facilitate communication between an inmate and a visitor or outsider. Specifically, the inmate kiosk (208) may be a combination of computing hardware and software used by an inmate to make and receive voice and video calls to/from a visitor, outsider, or another inmate residing in another controlled facility (not shown). The inmate kiosk (208) may also be used to schedule a voice or video call with a visitor at a future date. Initiating or scheduling a voice or video call may include determining whether the currently attempted call, or the scheduled call, is adverse to one or more restrictions (e.g., inmate use restrictions, device use restrictions, and/or inmate target restrictions). Further, the inmate kiosk (208) may also include the functionality to exchange media (e.g., photos, videos, and audio) with a visitor or outsider. The inmate kiosk (208) may include functionality to generate such media, such as a camera, microphone, keyboard, and software to record or otherwise create media to send to a visitor or outsider. Such media may be subject to review before being delivered.

In at least one implementation of the claimed embodiments, an inmate wanting to use an inmate kiosk (208) may be required to participate in an authentication process to verify the identity of the inmate. The authentication process may include providing verification data for comparison to verified data previously obtained from the inmate and stored in the inmate identity data item. The verified data may be a username and password combination and/or biometric information about the inmate.

In at least one implementation of the claimed embodiments, the inmate kiosk (208) includes functionality to access a secure social network. Specifically, the inmate kiosk (208) may be used by an inmate to manage a secure social network account. The inmate kiosk (208) may include functionality to generate such media, such as a camera, microphone, keyboard, and software to record or otherwise create media to send to a visitor or outsider. The inmate kiosk (208) may also be used by an inmate to upload digital media to the inmate's secure social network account or the account of another secure social network member. The inmate kiosk (208) may further be used to view digital media uploaded to the inmate's social network account or the account of another secure social network member. Uploaded media may be subject to review before posting.

In at least one implementation of the claimed embodiments, the inmate kiosk (208) includes functionality to manage a commissary account for the inmate. Specifically, an inmate may use an inmate kiosk (208) to view a transaction history of the commissary account and/or to apply commissary funds for goods and services consumed or enjoyed by the inmate. Further detail about the inmate kiosk (208) is provided in FIG. 5A and FIG. 5B.

In at least one implementation of the claimed embodiments, the inmate phone (210) is a device with functionality to send and receive audio communications between an inmate and an outsider or visitor. The inmate phone (210) may be implemented as handset connected to a telephone line. In at least one implementation of the claimed embodiments, all or part of the voice call may be conducted over a VoIP connection. In at least one implementation of the claimed embodiments, a single inmate phone (210) is utilized by multiple inmates.

In at least one implementation of the claimed embodiments, initiating or receiving a voice call using the inmate phone (210) requires a form of authentication (e.g., providing a password, personal identification number, or voice verification). In at least one implementation of the claimed embodiments, voice calls made using the inmate phone (210) are monitored by one or more administrators using the administrator computing device (206), and are recorded and stored in a data storage system within the controlled facility (200), within the outside facility (not shown), or within a third-party provider (not shown). The inmate phone (210) may also be subject to device use restrictions limiting the ability to use the inmate phone (210) at certain times (e.g., between 9 PM and 8 AM) or under certain conditions (e.g., emergency lockdown).

In at least one implementation of the claimed embodiments, the identity of the visitor or outsider targeted by the inmate or attempting to contact the inmate using the inmate phone (210) is verified against inmate target restrictions imposed on the inmate. Such restrictions may be associated with the inmate's identity data item and may be stored locally within the controlled facility (200), within the outside facility (not shown), or within a third-party provider (not shown). The visitor or outsider identity may be verified by the local server (214) or by another server within the outside facility (not shown), or within a third-party provider (not shown).

In at least one implementation of the claimed embodiments, the inmate computing device (212) is a computing system configured to execute the inmate application (202). In at least one implementation of the claimed embodiments, each inmate computing device (212) is utilized exclusively by a single inmate. In at least one implementation of the claimed embodiments, access to the inmate application requires a form of initial authentication. This initial authentication may use verification data stored locally on the inmate computing device (212) (e.g., a code or combination used to unlock the phone, locally stored biometric data, etc.).

In at least one implementation of the claimed embodiments, accessing a communications network (e.g., communications network (216)) using the inmate application (220) may require further network-based authentication. This further authentication may use verification data stored external to the inmate computing device (212) but locally within the controlled facility (200), or remotely within the outside facility (not shown) or within a third-party provider (not shown).

In at least one implementation of the claimed embodiments, an authenticated inmate may use the inmate application to initiate or receive voice or video calls, initiate or receive text or media messages, schedule a voice or video call, manage a commissary account, or post media to a secure social network. In at least one implementation of the claimed embodiments, voice and video calls made using the inmate computing device (212) are monitored by one or more administrators using the administrator computing device (206), and are recorded and stored in a data storage system within the controlled facility (200), within the outside facility (not shown), or within a third-party provider (not shown).

In at least one implementation of the claimed embodiments, the identity of the visitor or outsider targeted by the inmate or attempting to contact the inmate using the inmate computing device (212) is verified against inmate target restrictions imposed on the inmate. Such restrictions may be associated with the inmate's identity data item and may be stored locally within the controlled facility (200), within the outside facility (not shown), or within a third-party provider (not shown). The visitor or outsider identity may be verified by the local server (214) or by another server within the outside facility (not shown), or within a third-party provider (not shown).

In at least one implementation of the claimed embodiments, the inmate computing system (212) and/or the inmate application (220) may limit access to the communications network (216) based on one or more restrictions (inmate use restrictions, inmate target restrictions, and device use restrictions). Further, the inmate computing system (212) and/or the inmate application (220) may gather data from input devices of the inmate computing system (212) to determine whether one or more restrictions apply. Such input devices may include, for example, a system clock, a global positioning system antenna, a wide area network antenna, etc.

In at least one implementation of the claimed embodiments, the local server (214) is a computer system or group of computers systems located within the controlled facility (200) that facility communication between inmates and visitors, outsiders, and/or other inmates. Specifically, the local server (214) may implement the software necessary to host voice and video calls between and among the visitor kiosk (202), the inmate kiosk (208), the inmate phone (210), and an outsider computing system (not shown). The local server (214) may also include functionality to enforce communication restrictions associated with the inmates using the inmate kiosk (208) or inmate phone (210). Alternatively, the local server (214) may merely provide access to other systems capable of hosting the communication software and data storage (e.g., located within an offsite facility or a third-party provider). Further, in at least one implementation of the claimed embodiments, the local server (214) includes functionality to regulate inmate access to a secure social network.

FIG. 3 shows an outside facility in accordance with at least one implementation of the claimed embodiments. As shown in FIG. 3, the outside facility (300) may include an application server (302), a database server (304), a reviewer computing system (306), and an investigator computing system (308). The application server (302) is communicatively coupled to the communications network (310). The reviewer computing device (306) may include a reviewer application (312), and the investigator computing device (308) may include an investigator application (314).

In at least one implementation of the claimed embodiments, the application server (302) is a computing system or group of computing systems configured to authenticate inmates, visitors, outsiders, administrators, reviewers, and/or investigators. Specifically, the application server (302) includes functionality to receive a request to authenticate an inmate, visitor, outsider, administrator, reviewer, and/or an investigator, retrieve verified data associated with the request, and compare the verified data to verification data submitted in the authentication request. In at least one implementation of the claimed embodiments, the application server provides access to identity data items and other data stored in the database server (304).

In at least one implementation of the claimed embodiments, the database server (304) is a computing system or group of computing system configured to store data about inmates, visitors, outsiders, administrators, reviewers, and/or investigators as well as communication data describing communications between and among inmates, visitors, outsiders, administrators, reviewers, and/or investigators. Data stored in the database server may include, but is not limited to, identity data items, verified data, approved communication media, communication media pending review

In at least one implementation of the claimed embodiments, the reviewer computing device (306) is a computing system configured to execute the reviewer application (312). In at least one implementation of the claimed embodiments, a reviewer is a person charged with viewing a media item submitted by an inmate, visitor, outsider or administrator, and determining one or more attributes of the media item. Based on the determined attributes of the media item, the reviewer may then approve the media item for transmission to its target inmate, visitor, or outsider. Alternatively, the reviewer may reject the media item, conditionally approve the media item, or redact parts of the media item, thus preventing complete transmission to its target inmate, visitor, or outsider. In at least one implementation of the claimed embodiments, the reviewer application (312) include functionality to view media items, associate one or more attributes to the media item, and/or mark the media items as approved or rejected.

In at least one implementation of the claimed embodiments, the investigator computing device (308) is a computing system configured to execute the investigator application (314). In at least one implementation of the claimed embodiments, an investigator is a person gathering information about an inmate, visitor, or outsider generally for the purposes of law enforcement. The investigator application (314) includes functionality to provide access to data stored on the database server (304) for investigative purposes.

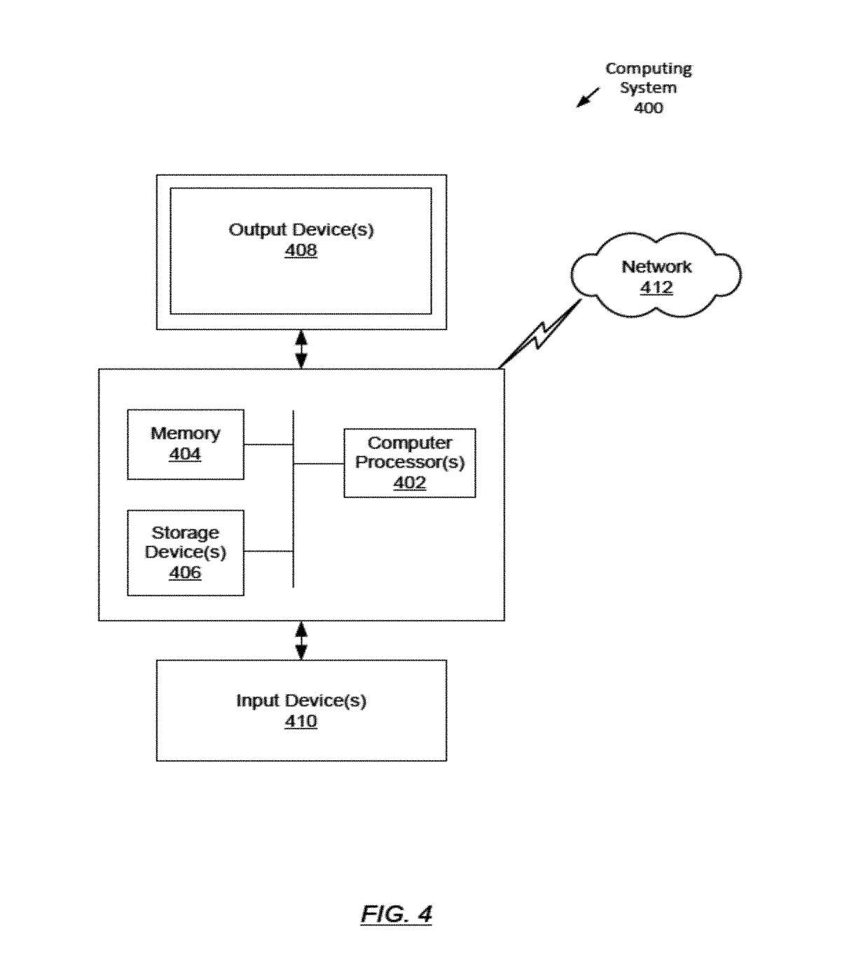

FIG. 4 shows a general computing system in accordance with at least one implementation of the claimed embodiments. As shown in FIG. 4, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, camera, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (400) may be connected to a network (414) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (400) may be located at a remote location and connected to the other elements over a network (414). Further, embodiments of the invention may be implemented on a distributed system having a plurality of nodes, where each portion of the invention may be located on a different node within the distributed system. In at least one implementation of the claimed embodiments, the node corresponds to a distinct computing device. Alternatively, the node may correspond to a computer processor with associated physical memory. The node may alternatively correspond to a computer processor or micro-core of a computer processor with shared memory and/or resources.

FIG. 5A shows a video visitation kiosk in accordance with at least one implementation of the claimed embodiments. Specifically, the video visitation kiosk (500) is a type of computing device as described in FIG. 4. As shown in FIG. 5A, the video visitation kiosk (500) includes a camera (502), a display (504), a handset (506), a headset jack (508), and a universal serial bus (USB) port (510).

FIG. 5B shows the hardware and software elements of a videoCC visitation kiosk in accordance with at least one implementation of the claimed embodiments. The hardware and software elements shown in FIG. 5B may be in addition to the elements described in FIG. 4. As shown in FIG. 5B, the video visitation kiosk (500) includes a handset (506), a video camera (502), a touch screen panel (512), a display (504), a computing application (514), an operating system (516), and a network interface controller (518).

FIG. 6 shows the hardware and software elements of a mobile computing device in accordance with at least one implementation of the claimed embodiments. Specifically, the mobile computing device (600) is a type of computing device as described in FIG. 4. The hardware and software elements shown in FIG. 6 may be in addition to the elements described in FIG. 4.

As shown in FIG. 6, the mobile computing device (600) may include a global positioning system (GPS) antenna (602), a cell antenna (604), a wide area network (WAN) antenna (606), and a personal area network (PAN) antenna (608), each connected to a multi-band radio transceiver (610). The mobile computing device (600) also may include a rear-facing video camera (612), a front-facing video camera (614), a compass (616), an accelerometer (618), a touch screen (620), a display (622), and a microphone (624). The mobile computing device (600) also may include a computing application (626) executing on an operating system (628).C

This disclosure also relates to methods and systems used in a detention environment for verifying an individual's identity utilizing a centralized database operable across disparate types of interactions. Current methods and systems for identity verification in detention environments are non-uniform for disparate types of interactions and the methods and systems are not easily compatible with one another. Therefore, it is difficult to track interactions of an individual and an individual subject to the detention environment. The disclosed method and system verify all individuals contacting, interacting with or otherwise connecting to an individual subject to the detention environment. In contrast, those individuals subject to the detention environment, such as inmates, patients, or detainees, may be verified using existing methods and systems since it is possible to obtain a wide range of information from the individual when they are in the detention environment. For example, when a prisoner is processed through a jail, it is common for the jail to obtain the prisoner's identity information such e.g., as fingerprints, DNA samples, and voice samples.

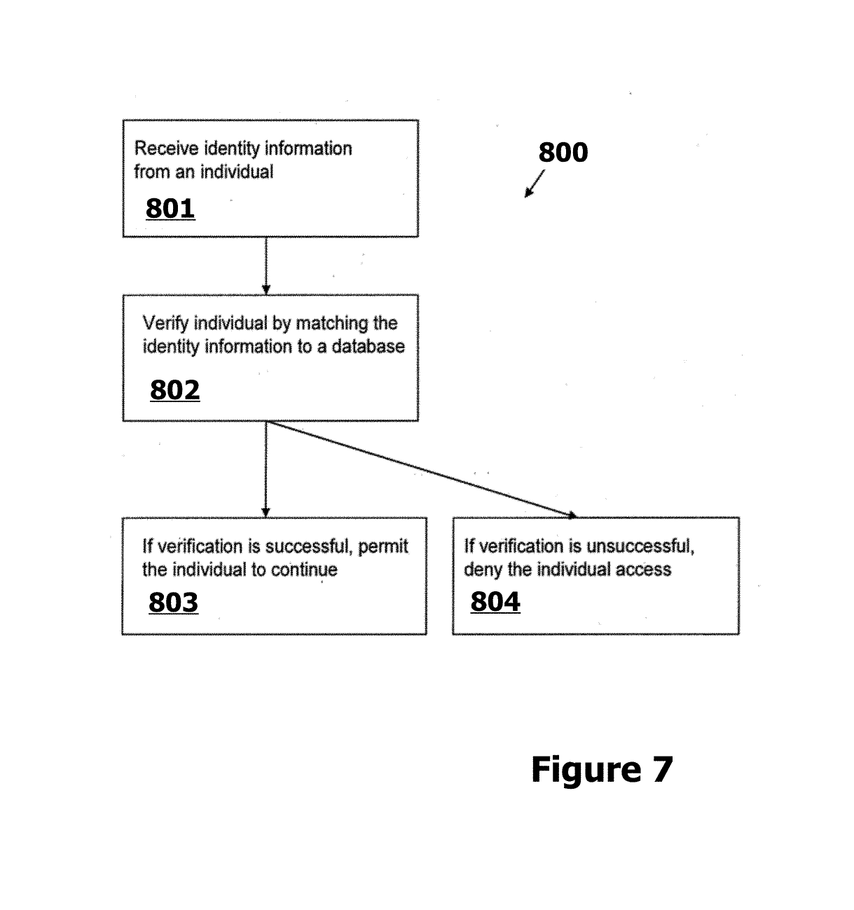

FIG. 7 is a diagram illustrating one embodiment of a method 800 according to aspects of the present disclosure. The method 800 is designed for use within a detention environment or as part of a method monitoring a detention environment. This method 800 applies to anyone who attempts to interact with an individual subject to a detention environment, for example, by visiting or making a transaction on behalf of the individual subject to the detention environment. As used herein, the term “individual” is used to refer to a person attempting to interact with, or on behalf of, a person subject to the detention environment who will be referred to herein as the “individual subject to the detention environment.” The method 800 receives the individual's identity information at step 801 by way of a programmable device or system, such as e.g., a computer, a call screening system, a detention environment guard, or an interactive audio/video system and device for use in a detention environment disclosed in U.S. patent application Ser. No. 13/088,883, which is incorporated by reference herein. It should be appreciated that where a definition or use of a term in an incorporated application or reference is inconsistent with or contrary to the definition of that term provided herein, the definition of that term provided herein applies. The individual could be prompted to input identity information, such as, the zip code of their residence, mother's maiden name, a number of digits of the applicant's social security number, or other questions that lead to a unique individual. Identity information may also be contained in an identification card, which is processed by the programmed device or system, and may assist with the verification process. As just one example, an individual may scan their driver's license, and the programmed device or system may read the license, and fill out form fields such as name, address, and gender based on information on the license. This process may be implemented by use of a magnetic strip, a two- dimensional or three-dimensional bar code, or optical character recognition. Identity information may also be biometric information, such as, facial recognition, body recognition, voice recognition, retinal scan, fingerprint, DNA sample, or palm print. Identity information may also come from an interaction with the individual's phone, such as, swiping a phone through a scanner, keying in a unique phrase or number that was sent to a phone, or answering a call made to the individual's phone.

The method 800 is also designed to verify an individual's identity by matching the individual's identity information with information in a database (at step 802). The database is populated with identity information from a data source or a plurality of data sources. In some cases the identity information from the data source existed prior to the individual's interaction with the individual subject to the detention environment. These data sources may include: line information databases to find phone number and address associations; best known name and address databases to associate names with addresses; identification verification databases to match a provided name with digits of a social security number or other unique participant-assigned number; national financial information databases for existing financial records; national passport database; other government issued identification database such as a drivers’ license database, a military identification database, or state issued identification card database; open warrants database; a national victim notification network such as VINE or VINELink; or a “do not contact” database. The database may also be

In some circumstances, an investigator will review attempted interactions with individuals subject to the detention environment. As just one example, an individual will attempt to interact by depositing money in the commissary account of an individual subject to the detention environment. The method 800 will check the database, and ask the individual enough questions until the method 800 is able to positively match the individual's identity information with information in the database. A consequence of this method 800 is that individuals will be verified upon each attempted interaction. For example, there may be several variations of J. Jones, J. D. Jones, Jonathan Jones, and John Jones appearing in a criminal investigation that involves attempted interactions with an individual subject to a detention environment. The identification of a J. Jones in a metropolitan area may require an extraordinary effort. Since the disclosed method 800 requires verification of an individual before he/she is allowed to interact with an individual subject to the detention environment, the disclosed method 800 may pinpoint the identity to a distinct individual named Jonathan D. Jones.

In an additional embodiment, the step of receiving identity information may also include receiving additional information from the individual after the individual is verified, such as e.g., a photograph or digital image of the individual, a scan of the individual's identification card, and additional information from additional questions. After the individual is verified, the individual may also establish a username and password, or a unique personal identification phrase, number, or series of characters. This establishment of a username and password would facilitate an additional identification process during future attempted interactions.

In another embodiment, the disclosed method supplements a verified identity with additional information from the database such as e.g., a date of birth, an address, and/or a photograph. In yet another embodiment, information, such as a phone number, associated with the individual is found to be associated with previous phone calls made by the individual subject to the detention environment. In this case, the disclosed method may associate those previous phone calls with the verified identity information, allowing the method to retroactively link a person in a detention environment to a specific verified person through a phone number. Similar associations could be made through credit card data, address data, and more.

In another embodiment, when an individual had been previously verified, the method 800 may receive a previously verified individual's username and password as the identity information during the verification process (i.e., step 801). The method 800 may also receive a previously verified individual's physical attributes as the identity information during the verification process. The physical attributes may include a voiceprint comparison, facial or body recognition, DNA sample, retinal scan, or other form of biometric attribute. The method 800 may also receive a previously verified individual's identification credential as the identity information during the verification process; this may include a passport, drivers license, military identification, or similar. The method 800 may also receive during the verification process a previously verified individual's mobile phone interaction as the identity information, which may involve responding to a phone call or text message, or requiring the previously verified individual to call or text message to a specific phone number. In the absence of all other means of identification, or as a means to expedite the process, the method 800 may receive a detention environment staff member's authorization to authenticate a verified individual by sight, or through spoken or direct questions.

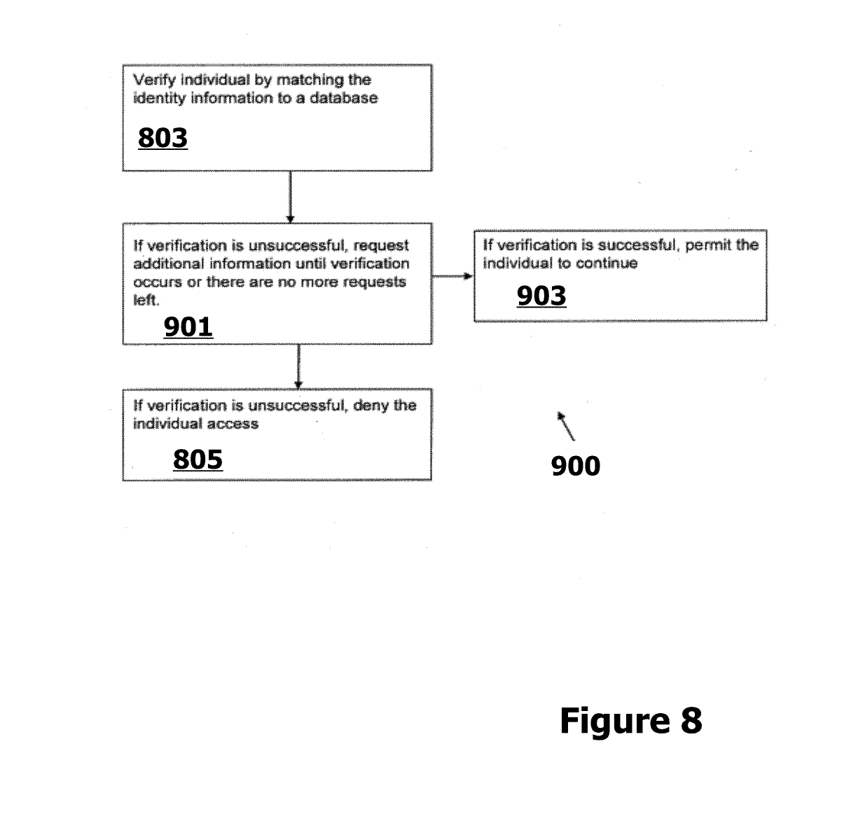

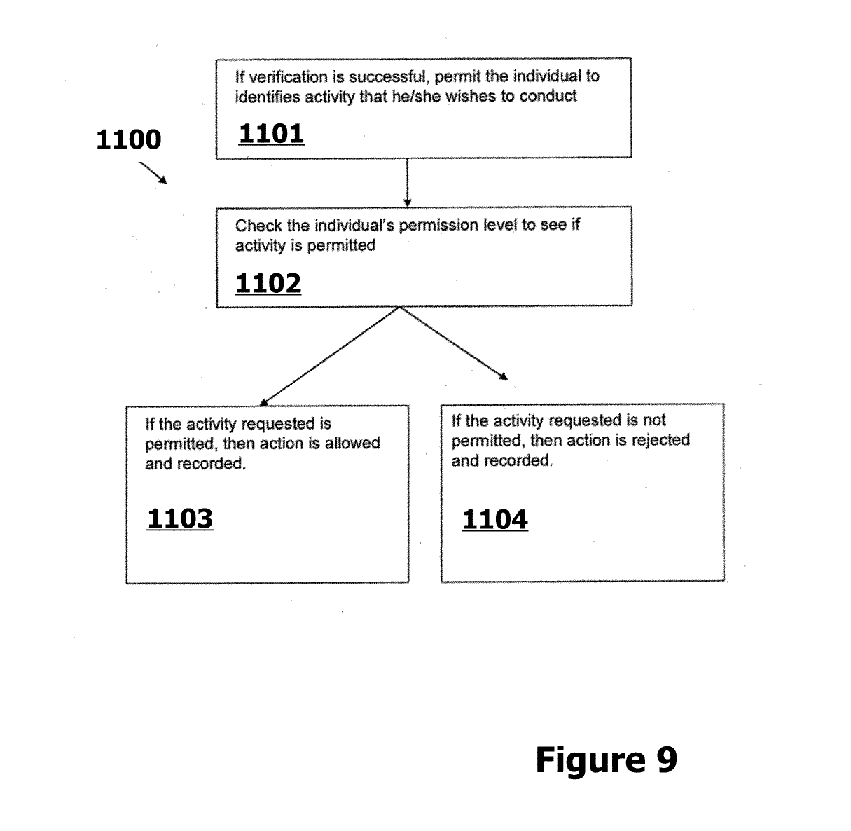

After step 802 is complete, the method 800 will either verify or not verify an individual's identity. The method 800 will either permit the individual to continue if the individual is verified at step 803, or deny the individual access if the individual is not verified at step 804. If the individual is not permitted to continue, then the method may proceed to the additional steps shown in FIG. 8. If the individual is permitted to continue, then the method may proceed to the additional steps shown in FIG. 9.

FIG. 8 illustrates an additional method designed for use when method 800 receives an individual's identity information, but fails to verify the individual. In that circumstance, method 900 will request additional identity information from the individual until a match is found or there are no more requests left to issue (step 901). The method 900 may request as many types of identity information from an individual as there are in the database. If verification is successful, the method 900 permits the individual to interact with the detention environment at step 903. If the verification is still unsuccessful, then the method 900 denies the individual interaction with the individual subject to the detention environment (step 804).

FIG. 9 illustrates an additional method 1100 designed to check an individual's permission level to determine whether a requested interaction is allowed. Once verification is successful (step 1003), the method 1100 permits the individual to request a particular interaction to conduct at step 1101 (e.g., placing a telephone call). The method 1100 then checks the verified individual's permission level to see if the requested activity is permitted (step 1102). If the interaction requested is permitted, the method 1100 permits the interaction and records the interaction at step 1103. If the activity requested is not permitted, then the interaction is rejected and the attempt is recorded at step 1104.

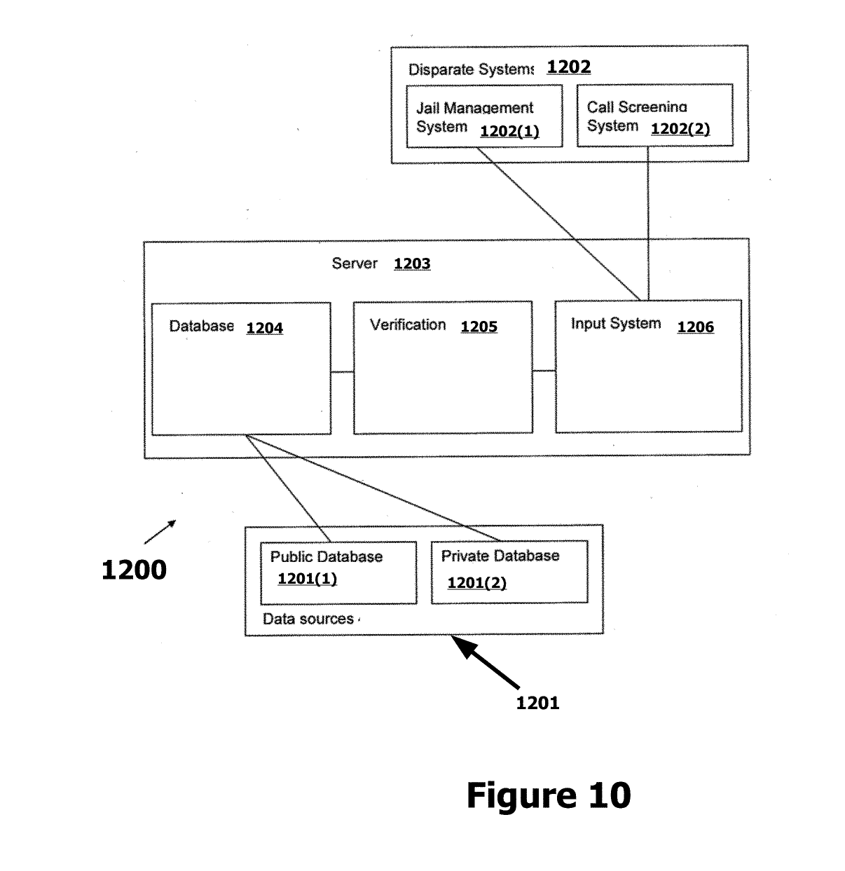

FIG. 10 is a diagram illustrating one embodiment of a system 1200 according to aspects of the present disclosure. The system 1200 includes a server 1203 comprising a database 1204, a verification system 1205, and an input system 1206. The server 1203 is programmed to perform one, all, or a combination of the methods 800, 900, 1100 disclosed herein. The database 1204 is populated with identity information from various data sources 1201, such as, a public database 1201(1) or a private database 1201(2). Public databases 1201(1) may include a line information database, best known name and address database, social security database, national financial information database, national passport database, government issued identification database, warrants database, national victim network database, or “do not contact” database. Private databases 1201(2) may include databases aggregated by the detention environment itself. In some cases the identity information from the data source 1201 existed prior to the individual's interaction with the individual subject to the detention environment. The database 1204 may also be populated by the data sources upon command, at intervals, or dynamically.

The system 1200 is preferably compatible with data sources 1201, such as e.g., the interactive audio/video system and device for use in a detention environment disclosed in U.S. patent application Ser. No. 13/088,883, the consolidated voicemail platform disclosed in U.S. patent application Ser. No. 12/826,168, an information exchange facilitating system such as e.g., the secure social network disclosed in U.S. patent application Ser. No. 13/438,940.

When an individual inputs information through one of the disparate systems 1202 for managing detention environment interactions, such as a jail management system 1202(1) or call screening system 1202(2), the server 1203 receives that information through its input system 1206. The verification system 1205 takes the information obtained through the input system 1206 and verifies the identifying information by matching it with the information stored in the database 1204.

In accordance with the practices of persons skilled in the art of computer programming, embodiments of the method 800, 900, 1100 are described with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits. Embodiments may also encompass integrated circuitry including circuit elements capable of performing specific system operations.

When implemented in a programmed device or system, the elements of the embodiments are essentially the code segments to perform the necessary tasks. The non-transitory code segments may be stored in a processor readable medium or computer readable medium, which may include any medium that may store or transfer information. Examples of such media include an electronic circuit, a semiconductor memory device, a read-only memory (ROM), a flash memory or other non-volatile memory, a floppy diskette, a CD-ROM, an optical disk, a hard disk, a fiber optic medium, etc. User input may include any combination of a keyboard, mouse, touch screen, voice command input, etc. User input may similarly be used to direct a browser application executing on a user's computing device to one or more network resources, such as web pages, from which computing resources may be accessed.

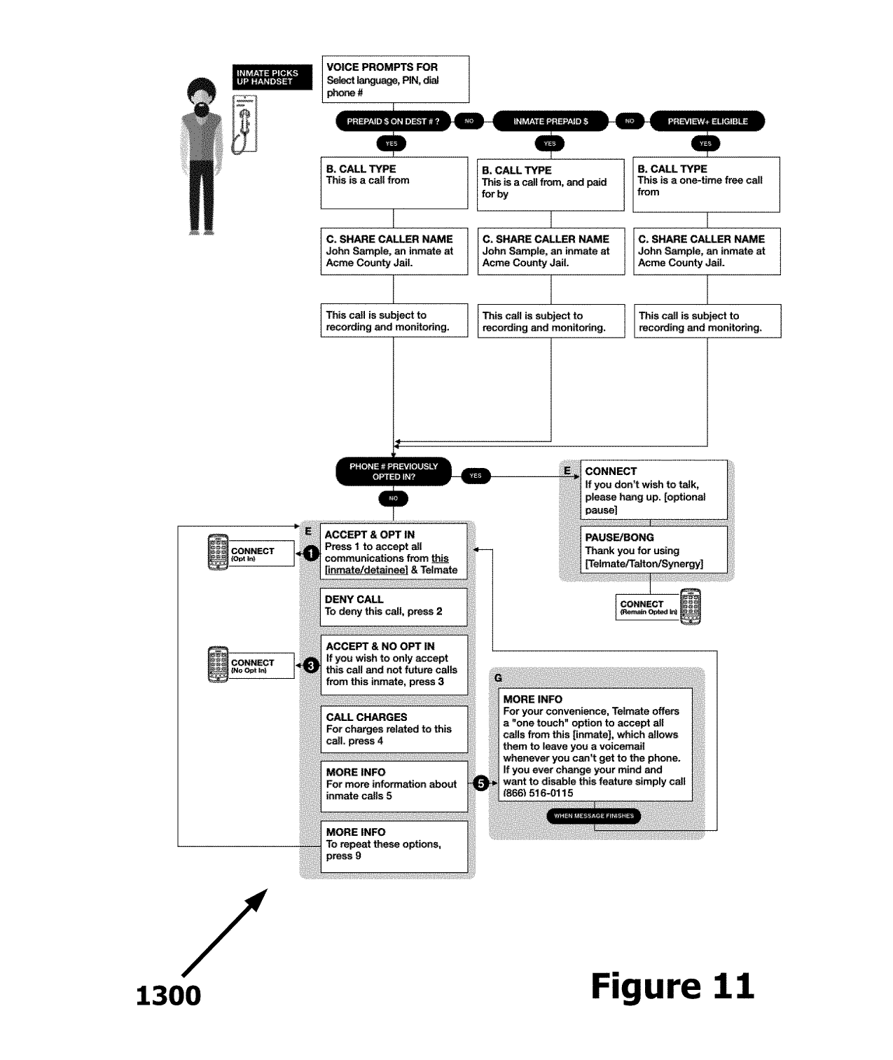

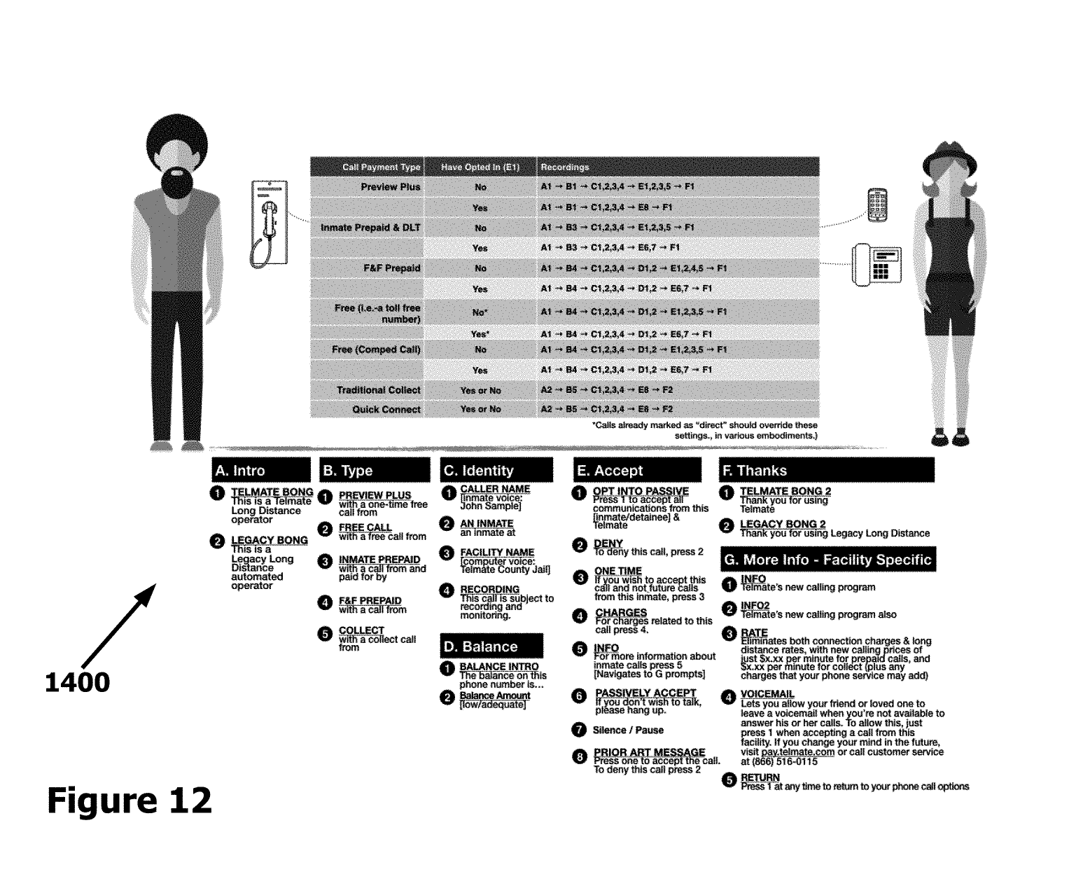

Now that some related environmental situations and systems have been described, this disclosure will now describe various embodiments regarding opt-in protocols for inmate-related communications such as the embodiments depicted in FIGS. 11-12.

Specifically, FIG. 11 is a flowchart diagram 1300 illustrating how an inmate call is handled based on the payment type of the call and further in relation to a called party's opt-in status. Related,

FIG. 12 is a chart diagram 1400 illustrating construction of applicable greetings played to a called party dependent on call type and opt-in/opt-out status.

In one embodiment, when an inmate, for example, telephones a friend or family member (“F&F”), the F&F will hear a typical pre-recorded message, upon answering their phone, that the call is from an inmate and are given a chance to hang up their phone. However, the message also includes an opt-in-type message and instructions such that, if the person ‘opts-in,’ future calls from the inmate will be prefaced by a much shorter recorded message regarding the new call or perhaps even no pre-recorded message in some embodiments. Once an opt-in is received, actual voice communications, on subsequent calls, between the inmate and the F&F will commence much sooner. For example, during calls after an opt-in, a call recipient would merely, in some embodiments, be given an option to hang up, before being voice-connected to the incarcerated individual calling party. Restated, they are no longer required to perform an action in order to be voice-connected. As previously stated, such actions may include pressing a specific button on a telephone keypad or perhaps orally saying the word ‘yes’ (or whichever word or phrase a specific system is configured to receive to establish the voice connection). As a direct result, an inmate will be more apt to communicate as a barrier to communication has been reduced or even possibly removed. For the F&F, they also will not need to be subjected to the same lengthy information each time an inmate makes the effort to reach out vis a phone call.

An alternative phrase to describe the opt-in is positive call-acceptance. It should be understood, though, that various expressions including the phrase ‘opt-in’ and/or phrases containing variations of ‘positive call acceptance’ may refer to similar embodiments described in this disclosure. However, it should be further understood there may also be other embodiments where variations of phrases containing ‘opt-in’ and/or ‘positive call acceptance’ are referring distinct and separate embodiments.

The following is text of an example, prior art, semi-custom pre-recorded message, that is typically played at the beginning of a connected phone call from an inmate to the dialed called party—the F&F:
“This is a Telmate Long Distance operator with a call from John Sample, an inmate at Central County Jail. This call is subject to recording and monitoring. Press 1 to accept this call. To deny this call, press 2.”

The semi-custom aspect is that the inmate's name is specified according to which inmate is initiating the call. In the above example, the inmate is “John Sample.” In some instances, the inmate may have pre-recorded their name, in their own voice, and that recording is then inserted at the appropriate spot in the above-listed example message text.

While this prior art message accomplishes such items as warning the F&F that the call is from an inmate and provides an opportunity to terminate the call before an actual voice connection is established, doing so can take a significant amount of time as compared to a typical non-inmate phone calls voice-connecting to a called party when the call is answered. Restated, the prior art message may take up to almost 30 seconds to play whereas a “normal” phone call, between two people neither of whom are in prison, does not involve time periods to communicate information. Typically, even if a called party is not available, during a “normal” call and there is a voicemail option, the time delay to when the caller is able to record a voicemail, to the called party, is still much shorter than the time it takes to recite the above-referenced prior art message. Extended length messages, typically included with inmate-originated phone calls, may also perhaps induce a called party to end the call prematurely because they are short on time or perhaps that the prior art message, unto itself, comes across as annoying, irritating, etc.

One example script, in accordance with various embodiments, after an F&F has opted in, is as follows:
“This is a call from John Sample, an inmate at Central County Jail. This call is subject to recording and monitoring. If you don't wish to talk, please hang up. Thank you for using Telmate.”

Prior to the above-listed example script, the F&F would have already opted in via a prior call or through other, similar methods.

In yet another embodiment, a called party is opted-in by default and would have an option to ‘opt-out’ to prior art-type messages when an inmate calls them.

It should be noted that shortened length, informational messages are part of a specific embodiment and may optionally be included in combination with other embodiments.

One example of providing an option to opt-in would be a voice direction to press a specific number on their phone keypad such as 1 or 2 or etc. A similar process could also be employed for opting-out-type situations. Other methods could also perhaps be employed such as spoken word recognition—“Say ‘yes’ to opt-in,” for example.

Various examples of inmate-related phone calls and how they are handled, in accordance with various embodiments:

New Number: The phone number has not been called or perhaps not had a person press one to “accept future calls” from the specific inmate that is calling.

The Call Type typically needs explicit called party permission such as an operator-assisted collect call paid for by the called party. Other call types including calls initiated by the inmate or other calls associated with calling cards set up to pay for inmate calls. One example may be from an account/calling card paid for by a F&F.

Call Recipient Requested Explicit (Positive) Call Acceptance for Each Call: A call recipient has specifically opted out of automatic call acceptance (or the number has been blocked). A blocked number is typically a number that has been deemed by a called party as a phone on which they do not wish to receive calls from all inmates or perhaps wish to not receive calls from one or more specific inmates but still receive calls from other inmates. It should be noted that the present disclosure is not necessarily limited to this specific definition.

Velocity Restrictions Met: An inmate has dialed the number more than a pre-specified number of times within a given time span (such as a calendar day).

Fixed Pricing: The call may not be rated for a fixed price and would therefore typically utilize a per minute pricing mechanis), in some embodiments. Other embodiments envision per second billing or even perhaps combinations of per second and per minute billing mechanisms.

### Additional Embodiment

One prior art practice typically utilized for inmate calls is that when the person who initiated the call (the inmate) hangs up, the call is terminated. With the new form of positive call acceptance, when a person opts in to accepting future calls from an inmate, inmates can leave voicemails. An informational message may be added to the end of the recording after the inmate hangs up. This informational message may include information about inmate calls, such as how to fund a prepaid account, or how to leave a voicemail for an inmate, or special promotions that Telmate may wish to share with the called party.

A few typical call flows when this occurs may be:

Inmate Call
1. Inmate dials a phone number
2. Called party answers
3. Called party actively accepts the call by saying a phrase of by pressing a keypad button
4. Called party speaks to the inmate
5. Inmate hangs up first
6. A marketing message is played for the called party
7. The call is terminated once the marketing message is complete.

F&F Voicemail with Positive Call Acceptance
1. Inmate dials a phone number
2. Someone has already opted to accept future calls to this number
3. Call recipient does not answer and voicemail is triggered
4. Because the called party has opted into accepting calls, the call is, by default, connected
5. Inmate leaves a message for the call recipient's voicemail
6. Inmate hangs up first
7. A marketing message is played for the called party
8. The call will then typically be terminated once the marketing message is complete

In addition to a marketing message, embodiments may allow the F&F to press a button to add funds to a prepaid account, or check their balance.

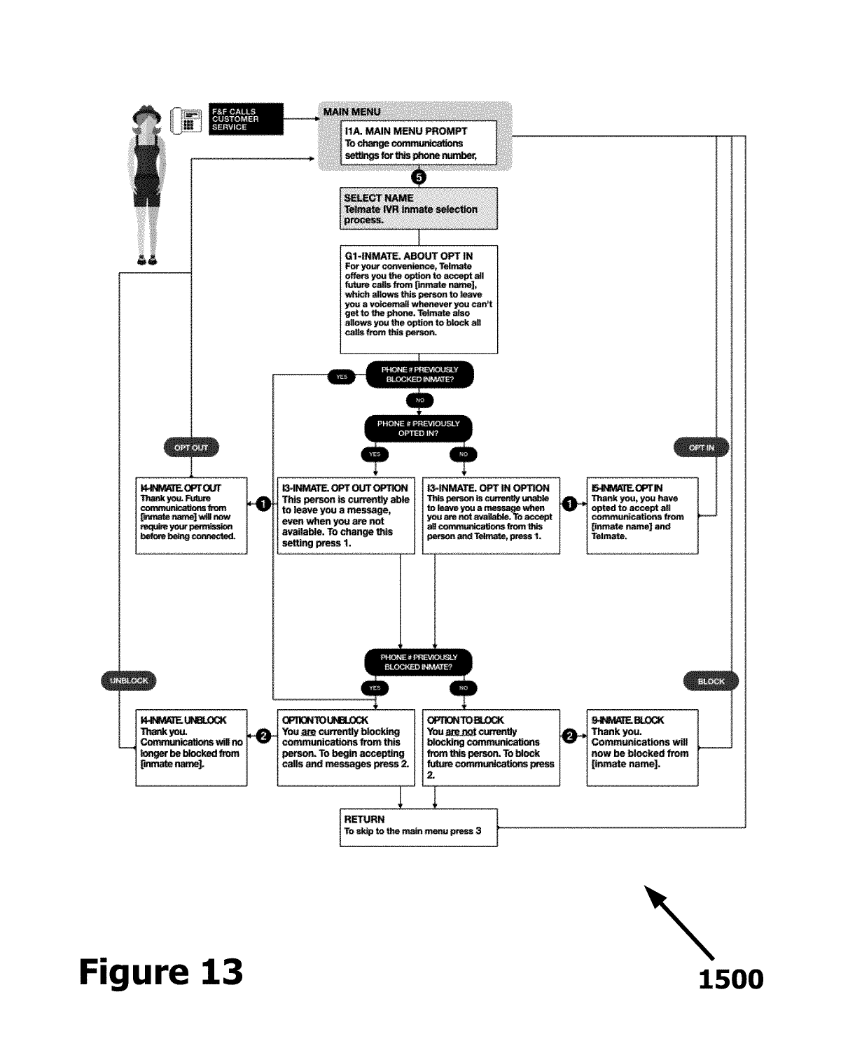

Embodiments may also tell the call recipient that they can call the number that appears in their caller ID in order to leave the inmate a voicemail. Inmate phones typically do not have unique phone numbers, so outbound calls are typically given a number that is displayed in Caller ID as coming from the Telmate customer service center. If a call recipient is listening to Telmate's marketing message from their phone's voicemail, their phone may provide them with the option of returning the call. By calling the number back, they will be presented with a range of automated options, including the option to leave a voicemail for an inmate, or add funds to an account. A F&F may also change their settings for a specific inmate such as blocking or unblocking calls from that inmate or opting into or out of inmate calls voice connecting to their phone with an active acceptance operation (opted out) or the calls going through with no active acceptance operation (opted-in). An example interactive voice response system menu, implementing the preceding description is shown via the flow chart diagram of FIG. 13.

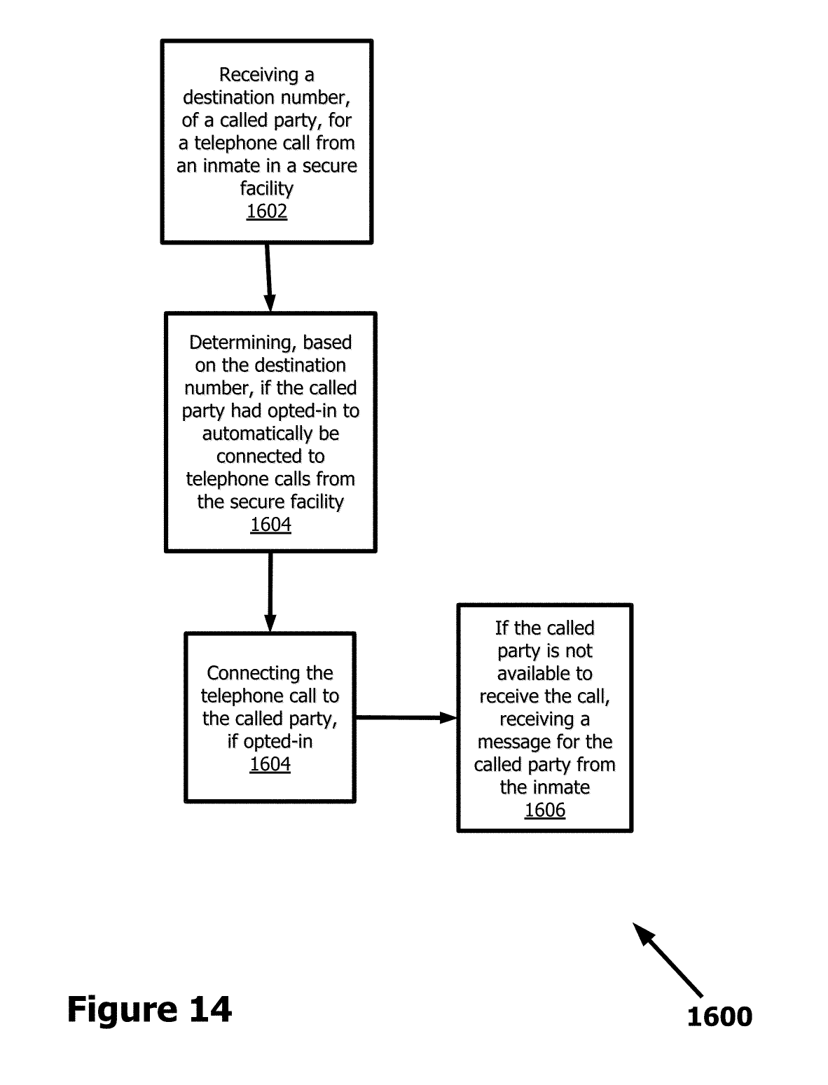

FIG. 14 is a flow chart diagram illustrating a computer-implemented method 1600 for prior opted-in call acceptance-assisted message delivery. The method 1600, which is typically executed by a processor such as the processor 402 of FIG. 4, includes receiving a destination number, of a called party, for a telephone call from an inmate in a secure facility (1602), determining, based on the destination number, if the called party had opted-in to automatically be connected to telephone calls from the secure facility (1604) and connecting the telephone call to the called party, if opted-in (1606). Also, if the called party is not available to receive the call, receiving a message for the called party from the inmate (1608).

While a number of exemplary aspects and embodiments have been discussed above, those of skill in the art will recognize certain modifications, permutations, additions and sub-combinations thereof. It is therefore intended that the following appended claims, and claims hereafter introduced, are interpreted to include all such modifications, permutations, additions and sub-combinations as are within their true spirit and scope.

What is claimed is:

1. A computer-implemented method for prior opted-in call acceptance-assisted message delivery comprising:
receiving a destination number, of a called party, for a telephone call from an inmate in a secure facility;
determining, based on the destination number, if the called party had opted-in to automatically be connected to telephone calls from the secure facility;
connecting the telephone call to the called party, if opted-in; and
if the called party is not available to receive the call, receiving a message for the called party from the inmate.

2. The method as recited on claim 2 further comprising providing system-related messages and options to the called party with delivery of the message.
